(19) United States
(12) Patent Application Publication
(10) Pub. No.: US 2011/0253243 A1
(43) Pub. Date: Oct. 20, 2011

(54) Flexible duct apparatus and method for use in aircraft environmental control systems

(76) Inventors: Reg Tomerlin, Los Angeles, CA (US); Allen W. Harwood, Fountain Valley, CA (US); Richard Hoff, Santa Ana, CA (US); Andrew Whitehead, Stockport (GB)

(21) Appl. No.: 12/928,601

(22) Filed: Dec. 15, 2010

Related U.S. Application Data
(60) Provisional application No. 61/284,227, filed on Dec. 15, 2009.

(51) Int. Cl. F16L 11/00

(52) U.S. Cl. 138/118

(57) ABSTRACT

A light-weight high-strength flame resistant flexible duct for use in the environmental control system of an air craft is formed of a generally circular cross section tube formed of a fluro-polymeric film joined along its length at an adhesive seam. The outer and inner surfaces of the tube are electronically treated to provide for enhanced adhesive bonding. A reinforcing cord formed of a self-reinforcing thermoplastic polymer is helically wound upon the tube and joined there to by adhesive.

### CROSS REFERENCE TO RELATED APPLICATIONS

This application claims the benefit of and priority under 35 USC 119(e) of U.S. Provisional Patent Application No. 61/284,227 entitled FLEXIBLE DUCT APPARTUS AND METHOD FOR USE IN AIRCRAFT ENVIRONMENTAL CONTROL SYSTEMS filed Dec. 15, 2009 in the name of Reg Tomerlin et al, the disclosure of which is incorporated herein by reference.

### FIELD OF THE INVENTION

This invention relates generally to fluid transport and circulation systems utilized in vehicles such as aircraft and the environmental control systems utilized therein. The present invention relates more particularly to a novel air circulation duct construction material, fabrication and method of fabrication therefore.

### BACKGROUND OF THE INVENTION

Commercial and private aircraft typically make use of flexible air ducting systems for the movement and transport of air throughout the occupied and pressurized cabin environment. These systems, generally referred to as environmental control systems, utilize ducts to circulate low pressure filtered air which is chemically and thermally conditioned. In the majority of aircraft construction, the ducting systems are commonly fabricated of a flexible duct apparatus comprised of a silicone rubber-coated fiberglass cloth which is reinforced with a cord of circular cross section material. The reinforcing cord is bonded adhesively about the fabric duct body in a helical pattern. The use of a helical reinforced cord provides strengthening for pressure resistance as well as maintaining a flexible duct which may be configured and flexed without causing collapse or occlusion.

In an art related to the environmental systems to which the present invention pertains, published US Patent application US2010/0044149 filed by Patel et al sets forth an ACOUSTIC MANAGEMENT OF FLUID FLOW WITHIN A DUCT in which apparatus and methods are described which provide for the management of noise associated with duct. A sound dampening apparatus is provided consisting of a duct through which a fluid flows such as an air duct. A flexuous cord is helically wound around the inner or outer surface of the duct at a pitch corresponding to a selected acoustical frequency range associated with the fluid flow through the duct.

U.S. Pat. No. 5,482,089 issued to Weber et al sets forth a FLEXIBLE CONDUIT FOR THE EXHAUST LINE FOR AN INTERNAL COMBUSTION ENGINE which includes a flexurally supple tube having several helical corrugations of equal pitch and a flexible supporting coil spring having its ends fixedly connected to flanges at opposite ends of the tube.

U.S. Pat. No. 6,105,620 issued to Haberi set forth a FLEXIBLE TUBE DEVICE having a flexible part comprising a flexible inner hose and a flexible outer hose provided along substantially the entire flexible portion and preferably between the outer hose and the inner hose a bend stiffening member is utilized which is plastically deformable and defines a generally helical shape.

U.S. Pat. No. 7,546,899 issued to Tomerlin et al sets forth a LIGHT-WEIGHT POLYMER MUFFLER APPARATUS AND METHOD OF MAKING SAME having a pair of tubular couplings at each end of a flexible corrugated conductive tube. The cover tube defines a plurality of corrugations.

Such duct construction provides flexibility and meets many of the needs of aircraft environmental control systems. However, such constructions have been shown to exhibit poor tear resistance, primarily due to breakage of the glass fibers within the fiberglass cloth body of the duct. In addition, present day flexible ducting apparatus increase the combustible fuel loading or available combustible material within the aircraft. Silicone rubber often requires the addition of fire retardants which increase the duct weight and reduce the mechanical properties of the fabricated duct. The addition of weight to the ducting system of the aircraft is particularly troublesome to aircraft designers. There exists a direct relationship between the weight of components within the ducting system and flammability. In essence, this relationship relates to the quantity of potentially flammable material or fuel which are provided to an aircraft fire.

The addition of weight is also reflected in the overall fuel efficiency and operating costs of the host aircraft. Despite the additional weight and flammability concerns which present day flexible duct fabrications impose upon aircraft designers, they continue to be utilized in routing and transporting fluids such as conditioned air throughout the modern aircraft. Flexible ducts continue to be easier to install than rigid metallic ducts and offer a lower-cost lighter weight alternative to rigid metallic ducts. The advantages during installation of ducted systems, which often occurs during the aircraft build process are substantial.

Several design criteria and constraints are imposed upon the ducting systems of environmental control apparatus which originate from governmental and industrial regulations on aircraft construction. Many of these regulations focus upon the safety of aircraft passengers and personal in the event of a catastrophe such as a aircraft fire. These constraints include attention given to flammability, toxicity and smoke generation during an aircraft fire. Recognizing the need for safety and protection of crew and passenger in the event of aircraft fires, the federal aviation authority (FAA) has implemented a succession of standards and regulations for materials utilized within aircraft environmental control systems. A new and currently developing flammability test is likely to be implemented in the near future and is generally referred to as “new radiant panel test” (NRPT). The essential components of this test are set forth as follows:

“The electric RHP (radiant heat panel) is calibrated to emit 1.13 W/cm2 on the zero position of the specimen tray. The fire ignition source (the pilot flame) is adjusted to have a flame blue inner cone length of 10 mm. After the equipment is calibrated, the 21.59 cm by 27.94 cm specimen material is exposed (soaked) to the radiant heat for one minute. After the one minute heat soak, the pilot flame is impinged on the specimen for fifteen seconds. The resulting burn length must be less than 5.08 cm, and the afterflame time must be less than forty five seconds.”

The clear goal of such a high standard of flammability is to make aircraft much safer by making the structures contained within the pressurized cabin more fire resistant and less likely to propagate fire thus providing more time for crew and passengers to escape in the event of an aircraft fire.

As a result, the challenges faced by aircraft designers in providing environmental control systems and ducting systems for use therein are substantial. The requirements of providing flexible ducting systems which meet the flammability, toxicity, and smoke generation regulations often require the addition of materials which increase the cost and weight of the ducting systems. Additional constraints found in tear resistance and as well as resistance to collapse or occlusion often necessitate the addition of materials and a resulting increase of the weight of the ducting systems.

Accordingly, there remains a well-established and long-standing and, prior to the present invention, unresolved need in the design of flexible ducting within aircraft environmental control systems which provides light-weight and high-strength ducting fabrications while simultaneously meeting the stringent requirements of safety involving flammability, toxicity and combustible fuel loading required by safety regulations.

### SUMMARY OF THE INVENTION

Accordingly, it is an object of the present invention to provide an improved flexible duct apparatus and method for use in an aircraft environmental control system. It is a more particular object of the present invention to provide an improved flexible duct apparatus and method for use in an aircraft environmental control system which is light-weight high-strength and flame resistant.

In accordance with the present invention, there is provided a light-weight high-strength flame resistant flexible duct for use in the environmental control system of an aircraft which is formed of a generally circular cross section electronically surface treated flouro-polymeric tube defining an inner surface and an outer surface together with a circular cross section reinforcing cord formed of a self-reinforcing thermoplastic polymer wound upon the tube outer surface in a generally helical wind. The circular cross section reinforcing cord is joined to the outer surface of the tube using a high-strength high-elongation silicone adhesive.

The present invention flexible duct provides a substantially lower-cost lighter-weight duct utilizing a flouro-polymeric tube formed of a film material produced by DuPont Corporation under the trademark FEP TEFLON which is electronically treated on both surfaces to provide surface chemistry for enhanced adhesive bonding. The reinforcement cord is fabricated from a thermoplastic polymer produced and sold by Solvay Advanced Polymers Corporation under the trademark Primospire SRP. The reinforcing cord is adhesively joined to the tube outer wall using an adhesive manufactured by NuSil Corporation which is sold under the trade name NUSIL 32/2186. The resulting duct provides substantial weight reduction not previously achieved by prior art flexible duct structures which exhibits substantial improvements in flammability and other combustion related testing while maintaining an improved high-strength tear resistance. The use of the thermoplastic polymer reinforcing cord provides a substantial decrease in the weight of cord used to reinforce the flouro-polymeric tube while increasing duct strength.

In further accordance with the present invention, there is provided for use in an aircraft environmental control systems, a flexible duct comprising: a light-weight high-strength flame resistant tube formed of a flouro-polymeric material defining a generally circular cross section having an inner surface and an outer surface; a helical reinforcing cord formed of a self-reinforcing circular cross section thermoplastic polymer wound upon the outer surface; and an adhesive attachment binding the helical reinforcing cord to the outer surface, the outer surface being electronically treated to enhance the bonding of adhesive attachment binding the helical reinforcing cord to the outer surface.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a perspective view of a flexible duct constructed in accordance with the present invention; and

FIG. 2 sets forth a partial section view of the present invention flexible duct taken along section lines 2-2 in FIG. 1.

### DESCRIPTION OF THE PREFERRED EMBODIMENT

By way of overview, the present invention sets forth a flexible duct for use in an aircraft environmental control system which utilizes a generally circular cross section duct body formed of a flouro-polymer material having electrostatically treated surfaces upon which a helically wound reinforcing polymer cord is secured. The reinforcing polymer cord is secured to the outer surface of the flouro-polymer tube by a high strength silicone adhesive. The combined structure provides a substantial reduction in overall weight of the flexible duct while simultaneously reducing the flammability and combustibility of the duct. Concurrently, the present invention flexible duct exhibits substantial improvement in strength and tear resistance. The reinforced polymer cord helically wound upon the flouro-polymer tube body provides increased strength and resistance to collapse.

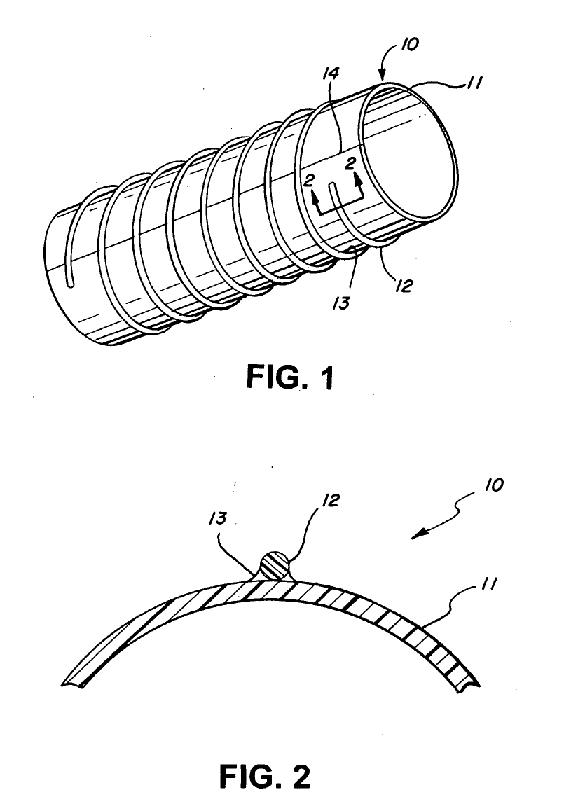

More specifically, FIG. 1 sets forth a perspective view of a flexible duct constructed in accordance with the present invention and generally referenced by numeral 10. It will be apparent to those skilled in the art that the present invention flexible duct is utilized within an aircraft body in segments which are of varying length to suit the various portions of the aircraft body being serviced. Thus, it will be understood that the length of flexible duct shown in FIG. 1 is merely illustrative and that the present invention flexible duct is fabricated in a variety of different lengths without departing from the spirit and scope of the present invention. Flexible duct 10 includes a generally circular thin walled duct body formed of a flouro-polymer material which is joined along a seam 14 running the length of the duct body using an adhesive attachment. Flexible duct 10 further includes a helically wound reinforcing cord 12 which is fabricated of a self reinforcing polymer cord. Cord 12 is joined to the outer surface of body 11 by a high-strength silicone adhesive. The resulting structure provides a substantial reduction in weight while improving tear resistance and fire resistance properties.

FIG. 2 sets forth a partial section view of flexible duct body 10 taken along section lines 2-2 in FIG. 1. As described above, flexible duct 10 includes a generally circular cross section body 11 having a reinforcing cord 12 helically wound thereon. Cord 12 is joined to the outer surface of body 11 by an adhesive 13.

The present invention flexible duct is preferably fabricated utilizing a tube formed of a flouro-polymeric material having a tube wall thickness less than or equal to 0.004 inches. In the preferred fabrication of the present invention, a film material produced by DuPont Corporation under the trademark FEP TEFLON is utilized. In its preferred form, the tube is fabricated utilizing a 0.002 inch thick fluorinated ethylene propylene film which is electronically treated on both surfaces to provide surface chemistry for enhanced adhesive bonding. This film provides a Limiting Oxygen Index of 95. This property means that the material will only burn in an environment comprised of ninety five percent or greater oxygen. The film also possesses high toughness and elongation strength making it more durable for use in the present invention flexible duct structure.

The preferred reinforcing cord is fabricated of self-reinforcing thermoplastic polymer which in its preferred form is fabricated by Solvay Advanced Polymers Corporation under the trademark Primospire SRP. Preferably the cord is circular in cross section and ranges in diameters from 0.025 to 0.120 inches. Typical diameter utilized extends from 0.038 to 0.050 inches. The cord material selected for the reinforcing cord of the present invention flexible duct exhibits a high tensile modulus of 800,000 psi which exceeds currently used thermoplastic polymers which more generally exhibit tensile modulus of 500,000 psi or less. As a result, the total cord diameter used in the reinforcing cord may be reduced thereby achieving a weight reduction while simultaneously maintaining sufficient stiffness and strength for optimum performance. This combination reduces the weight of reinforcing cord and the weight of corresponding adhesive required for bonding the cord to the tube dramatically. It has been found that the weight advantage (reduction in weight) achieved by this construction is substantially doubled when compared to correspondingly sized prior art flexible duct structures. The overall Limiting Oxygen Index is fifty five which provides an overall fire resistance achieved by smaller cord diameter and reduced adhesive which greatly reduces the fuel loading of the duct system. Flammability is correspondingly enhanced while a similar improvement is created with respect to smoke and toxicity. These improvements are achieved by utilizing fire resistant improved materials and limiting the quantities required which in turn reduces the release of toxic gases and smoke in the event of an aircraft fire.

The present invention flexible duct is a bonded constructed created by adhesively joining the film wall forming the tube to the thermoplastic cord proving reinforcing support while utilizing an high-strength high-elongation silicone adhesive. The latter has been found to be particularly effective in that it chemically bonds and joins the advanced polymeric component with outstanding tolerance to the state of surface preparation and surface chemistry of the material. This tolerance provides substantial improvement in the production environment.

What has been shown is a novel flexible duct for use in aircraft environmental control systems which reduces overall duct weight while simultaneously improving the strength and collapse resistance of the duct. Concurrently, the present invention flexible duct exhibits substantial improvement in combustion related properties and thus provides enhanced safety for passengers and crew within the host aircraft in the event of an aircraft fire.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. For use in an aircraft environmental control systems, a flexible duct comprising:
a light-weight high-strength flame resistant tube formed of a flouro-polymeric material defining a generally circular cross section having an inner surface and an outer surface;
a helical reinforcing cord formed of a self-reinforcing circular cross section thermoplastic polymer wound upon said outer surface; and
an adhesive attachment binding said helical reinforcing cord to said outer surface,
said outer surface being electronically treated to enhance the bonding of adhesive attachment binding said helical reinforcing cord to said outer surface.

2. The flexible duct set forth in claim 1 wherein said tube is formed of a generally planar sheet of said flouro-polymeric material having opposed edges joined to form said tube.

3. The flexible duct set forth in claim 2 wherein said opposed edges are joined by adhesive bonding.

4. The flexible duct set forth in claim 3 wherein said planar sheet comprises a fluorinated ethylene propylene film electronically treated on both surfaces to provide enhanced adhesive bonding and having a thickness between 0.001 inch to 0.003 inches.

5. The flexible duct set forth in claim 3 wherein said fluorinated ethylene propylene film defines a thickness of 0.002 inches.

6. The flexible duct set forth in claim 5 wherein said helical reinforcing cord defines a diameter between 0.025 inches to 0.120 inches.

7. The flexible duct set forth in claim 6 wherein said helical reinforcing cord defines a diameter between 0.038 inches and 0.050 inches.

8. The flexible duct set forth in claim 7 wherein said helical reinforcing cord exhibits a tensile modulus exceeding 750,000 pounds per square inch.

9. The flexible duct set forth in claim 8 wherein said adhesive attachment binding said helical reinforcing cord to said outer surface includes a high-strength high-elongation silicone adhesive.

10. The flexible duct set forth in claim 1 wherein said helical reinforcing cord defines a diameter between 0.025 inches to 0.120 inches.

11. The flexible duct set forth in claim 10 wherein said helical reinforcing cord defines a diameter between 0.038 inches and 0.050 inches.

12. The flexible duct set forth in claim 11 wherein said helical reinforcing cord exhibits a tensile modulus exceeding 750,000 pounds per square inch.

13. The flexible duct set forth in claim 12 wherein said adhesive attachment binding said helical reinforcing cord to said outer surface includes a high-strength high-elongation silicone adhesive.

14. The flexible duct set forth in claim 1 wherein said tube defines a wall thickness between 0.001 inches and 0.003 inches.

15. The flexible duct set forth in claim 14 wherein said tube defines a wall thickness of 0.002 inches.

16. For use in an aircraft environmental control systems, a flexible duct comprising:
a light-weight high-strength flame resistant tube formed of a flouro-polymeric material defining a generally circular cross section having an inner surface and an outer surface;
an elongated reinforcing cord formed of a self-reinforcing thermoplastic polymer wound upon said outer surface; and
an adhesive attachment binding said reinforcing cord to said outer surface,
said outer surface being electronically treated to enhance the bonding of adhesive attachment binding said reinforcing cord to said outer surface.

17. The flexible duct set forth in claim 16 wherein said reinforcing cord defines a generally circular cross section.

18. The flexible duct set forth in claim 17 wherein said reinforcing cord is helically disposed on said outer surface.
